(19) United States
(12) Patent Application Publication
(10) Pub. No.: US 2014/0214730 A9
(43) Pub. Date: Jul. 31, 2014

(54) SYSTEM AND METHOD FOR NEURAL MODELING OF NEUROPHYSIOLOGICAL DATA

(71) Applicants: Goded Shahaf, Haifa (IL); Noga Pinchuk, Zikhron-Yaakov (IL); Guy Ben-Bassat, Kibbutz Beit Zera- Doar-Na Emek Ha Yarde (IL); Amir B. Geva, Tel-Aviv (IL); Israel Tauber, RaAnana (IL); Amit Reches, Haifa (IL); Ayelet Kanter, Yokneam Ilit (IL); Urit Gordon, Kiryat-Tivon (IL)

(72) Inventors: Goded Shahaf, Haifa (IL); Noga Pinchuk, Zikhron-Yaakov (IL); Guy Ben-Bassat, Kibbutz Beit Zera- Doar-Na Emek Ha Yarde (IL); Amir B. Geva, Tel-Aviv (IL); Israel Tauber, RaAnana (IL); Amit Reches, Haifa (IL); Ayelet Kanter, Yokneam Ilit (IL); Urit Gordon, Kiryat-Tivon (IL)

(21) Appl. No.: 12/745,558

(22) PCT Filed: Nov. 30, 2008
(86) PCT No.: PCT/IL08/01559

§ 371 Date: Sep. 20, 2010

Related U.S. Application Data
(63) Continuation-in-part of application No. 12/302,271, filed on May 26, 2009, now Pat. No. 8,320,649.
(60) Provisional application No. 60/990,945, filed on Nov. 29, 2007.
(60) Provisional application No. 60/899,385, filed on Feb. 5, 2007.

(51) Int. Cl. G06N 3/02; G06F 15/18; G06F 17/00

(52) U.S. Cl. 706/11; 706/15

(57) ABSTRACT

Systems and methods for constructing a neural model, wherein the system and method comprises analyzing neuropsychological data to obtain the model and modeling functional plasticity.

### FIELD OF THE INVENTION

The present invention relates to methods of modeling neuropsychological data and more particularly to methods of providing models, testing models and combining models.

### BACKGROUND OF THE INVENTION

It is known in the field of neuropsychology that behavioral functions are based upon flow among various functional regions in the brain, involving specific spatiotemporal flow patterns. Likewise, behavioral pathologies are often indicated by a change in the patterns of flow. The specific spatiotemporal pattern underlying a certain behavioral function or pathology is composed of functional brain regions, which are often active for many tens of milliseconds and more. The flow of activity among those regions is often synchronization-based, even at the millisecond level and sometimes with specific time delays.

Models are commonly used in the field of neurology to gain understanding about the behavioral functions of the various regions of the brain and their interaction or flow, producing these spatiotemporal flow patterns. Understanding of the spatiotemporal pattern may be gained by using models. However, different models may be hypothesized for the same set of observations or data. Furthermore, there are a vast number of regions in the brain and potentially an equal amount of models to explain its function. Accordingly, to date it has been difficult to construct and test a unifying model able to explain observations relating to more than one specific region of the brain.

Currently, models are specific to an individual data set and cannot be extrapolated, related or correlated to other existing problems or data sets.

### SUMMARY OF THE INVENTION

The background art does not teach or suggest a method for analyzing neurophysiological data using a unifying modeling platform. The background art does not teach or suggest a unifying modeling system and method. The background art also does not teach or suggest a unified modeling system that allows models to be integrated, related and tested against one another. The background art also does not teach or suggest a system that allows model abstraction, for testing observed data or hypotheses.

The present invention overcomes these drawbacks of the background art by providing a method to analyze neurophysiological data, and/or optionally behavioral and/or other types of neurological data, to construct one or more models that explain the observed data.

Neurophysiological data includes any type of signals obtained from the brain. Such signals may be measured through such tools as EEG is (electroencephalogram), which is produced using electroencephalography. Electroencephalography is the neurophysiologic measurement of the electrical activity of the brain (actually voltage differences between different parts of the brain), performed by recording from electrodes placed on the scalp or sometimes in or on brain tissue. As used herein, the term “neurophysiological data” also refers to brain imaging tools, including but not limited to CAT (computed tomography) scans, PET (positron emission tomography) scans, magnetic resonance imaging (MRI) and functional magnetic resonance imaging (fMRI), ultrasound and single photon emission computed tomography (SPECT).

Optionally and preferably, the model also features neuropsychological data, for example from a knowledgebase or any type of database. The information may optionally be obtained from literature and/or from previous studies, including studies performed according to one or more aspects of the present invention, for example as described herein and/or as described in PCT Application No. PCT/IL2007/000639, by the present inventors and owned in common with the present application.

The present invention also encompasses a system and method for unifying models based on neurophysiological data forming a comprehensive neural modeling platform. An embodiment of the present invention provides for a platform able to analyze, test and integrate different models. Optionally and preferably the comprehensive modeling platform of the present invention provides a neural model knowledgebase that may be defined and updated. Optionally and preferably the knowledgebase is based on published data and experimental data. Optionally and preferably the knowledgebase may be organized by function or location.

A further optional embodiment of the present invention provides a research tool that optionally allows researchers to model different areas of the brain. Optionally, individual areas of the brain may correspond to at least one or more models. An optional embodiment of the present invention provides researchers with an interface having a model knowledgebase to perform at least one or more tasks for example including but not limited to incorporating an existing model into the platform, building a model around their specific data, searching for an existing model(s) that fit their data, combining different models, relate known models to specific research articles or data in the field.

Optionally the models abstracted within the platform of the present invention may be used to model a plurality of data or an individual data set. For example, a plurality of data may be grouped and analyzed to perform group analysis, relating a model to the common features of the group. Alternatively, the model platform of the present invention may optionally produce a specific individualized model based on an individual data set, optionally corresponding to an individual, effectively producing a brain model fingerprint of the individual.

A further optional embodiment of the present invention provides for a neural modeling platform for modeling functional plasticity, disease state or normal state modeling. For example, it is possible to adjust the model for someone who is suffering from brain damage or disease. Also once recovery has started, as for example in a patient who had a stroke and initially could not speak, but then recovered the ability to speak, it is possible to map functional plasticity changes in the brain, preferably with regard to areas of the brain that are affected.

According to some embodiments of the present invention, the neurophysiological models are optionally abstracted based on data which comprises EEG data and/or source localization data. The EEG data is preferably decomposed to given format producing a common base from which the models may be abstracted, tested and integrated.

Although the present description centers around models constructed by using EEG data, it should be noted that this is for the purpose of illustration only and is not meant to be limiting in any way. Any type of brain imaging data may optionally be used, including but not limited to CAT (computed tomography) scans, PET (positron emission tomography) scans, magnetic resonance imaging (MRI) and functional magnetic resonance imaging (fMRI), ultrasound, MEG (magnetoencephalography) and single photon emission computed tomography (SPECT), or any other noninvasive or invasive method and/or combinations thereof. Optionally, a plurality of different types of data may be combined for determining one or more models as described herein.

According to some embodiments of the present invention, there is provided a method for constructing a neural model, comprising analyzing neurophysiological data to obtain the model. Optionally, the method further comprises modeling functional plasticity. Preferably, the modeling functional plasticity comprises modeling recovery from a disease state.

Optionally, the method further comprises modeling a disease state.

Optionally, the method further comprises modeling a normal state. Optionally and preferably, the method further comprises constructing a simulation of the neural model. More preferably, the constructing the simulation comprises determining expected data for the model. Most preferably, the constructing the simulation further comprises pruning the expected data to obtain a better fit to the model. Also most preferably, the constructing the simulation further comprises comparing the expected data to the neurophysiological data.

Optionally, the method further comprises observing a behavior; and constructing the model at least partially according to the behavior. Preferably, the behavior comprises performing an action or activity by a subject. More preferably, the constructing the model comprises constructing a plurality of models; and selecting a model from the plurality of models according to the neurophysiological data. Most preferably, the selecting the model comprises determining a likelihood of the neurophysiological data fitting the plurality of models; and determining the model having a greatest likelihood of the data fitting the model.

Also most preferably, the selecting the model further comprises performing at least one additional test to obtain additional neurophysiological data for comparison to the model.

Also most preferably, the determining the likelihood and the performing at least one additional test is performed more than once.

Preferably, the constructing the plurality of models further comprises arranging the plurality of models into a hierarchical structure according to specific areas of brain activity; and wherein the selecting the model further comprises selecting the model according to at least one specific area of brain activity.

According to any of the above embodiments, the neurophysiological data comprises one or more of EEG (electroencephalogram) signal data, CAT (computed tomography) scan data, PET (positron emission tomography) scan data, magnetic resonance imaging (MRI) data and functional magnetic resonance imaging (fMRI) data, ultrasound data, and single photon emission computed tomography (SPECT) data.

Preferably, the neurophysiological data comprises source localization data.

According to other embodiments, there is provided a system for establishing a knowledgebase of neuropsychological models, wherein the knowledgebase is constructed according to the above described method, further comprising an interface for accessing the knowledgebase, wherein the interface and the knowledgebase are operated through a computer or network of computers. Optionally, the knowledgebase is searchable. Preferably, the knowledgebase comprises a plurality of brain model fingerprints for a plurality of individuals.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Although the present invention is described in some embodiments with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

### BRIEF DESCRIPTION OF THE DRAWINGS

The above and further advantages of the present invention may be better understood by referring to the following description in conjunction with the accompanying drawings in which:

FIG. 1A-C are illustrative diagrams of EEG signals and localization maps optionally used to abstract a neural model according to an optional embodiment of the present invention.

FIG. 1D is a block diagram illustration of the neural modeling system in accordance with an optional embodiments of the present invention; and

FIG. 2 is a block diagram illustration depicting the interaction between model processor and knowledgebase according to an optional system and method of the present invention; and

FIG. 3 is a block diagram illustration of the functions of the model processor according to an optional embodiment of the present invention; and

FIGS. 4A and 4B show exemplary user interfaces of the neural modeling platform research tool according to an optional embodiment of the present invention;

FIG. 5A is a flow chart of an exemplary depiction of the research tools according to an optional embodiment of the present invention;

FIG. 5B is an example of the functions of the research tool according to FIG. 5A;

FIGS. 6A-6E are schematic illustrations of flow patterns showing connectivity between functional regions that may be modeled; And

FIG. 7 relates to an exemplary embodiment of a system according to the present invention.

It will be appreciated that for simplicity and clarity of illustration, elements shown in the drawings have not necessarily been drawn accurately or to scale. For example, the dimensions of some of the elements to may be exaggerated relative to other elements for clarity or several physical components may be included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of the present invention. It will be understood by those of ordinary skill in the art that the present invention may be practiced without these specific details. In other instances, well-known methods, procedures, components and structures may not have been described in detail so as not to obscure the present invention.

The present invention is directed to a system and method for neural modeling of neuropsychological processes. The principles and operation of methods according to the present invention may be better understood with reference to the drawings and accompanying descriptions.

Before explaining at least one embodiment of the present invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

The present invention, in some embodiments, is directed to a platform that may be used for test groups or individual subjects, to analyze and identify models that explain observed brain activity or neuropsychological patterns, related to behavior. The present invention is further directed to a platform that correlates neural models with a particular pathological or non-pathological state. The instant invention further provides a research tool for testing, integrating, and abstracting neural models specific to raw neurophysiological data or processed data for example including but not limited to localization maps.

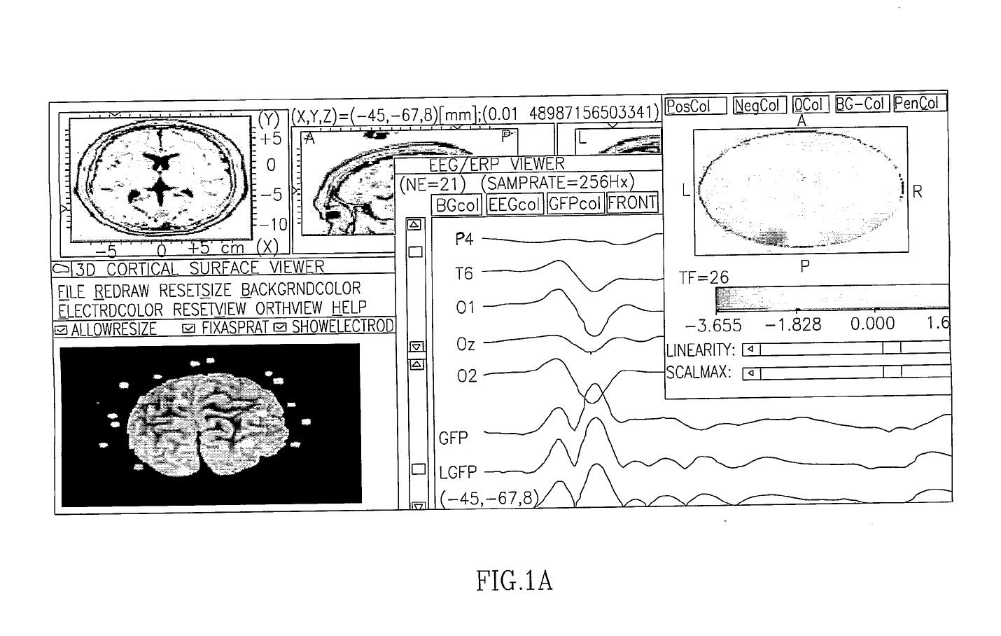

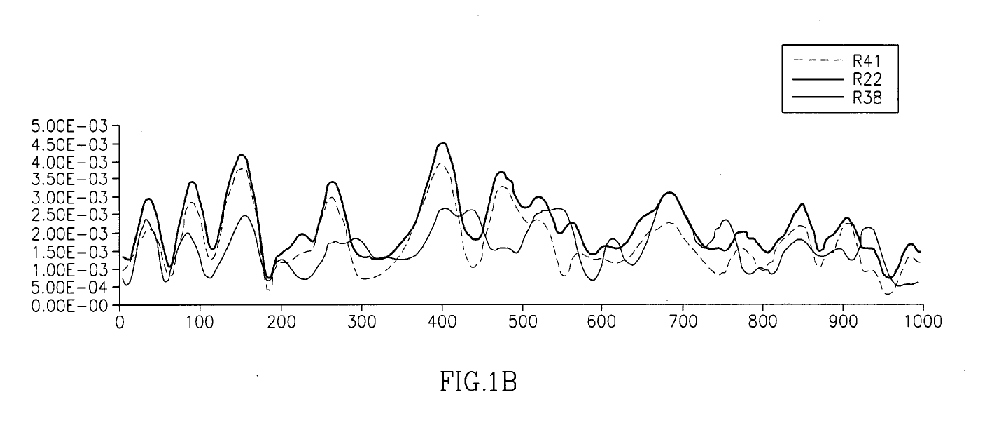

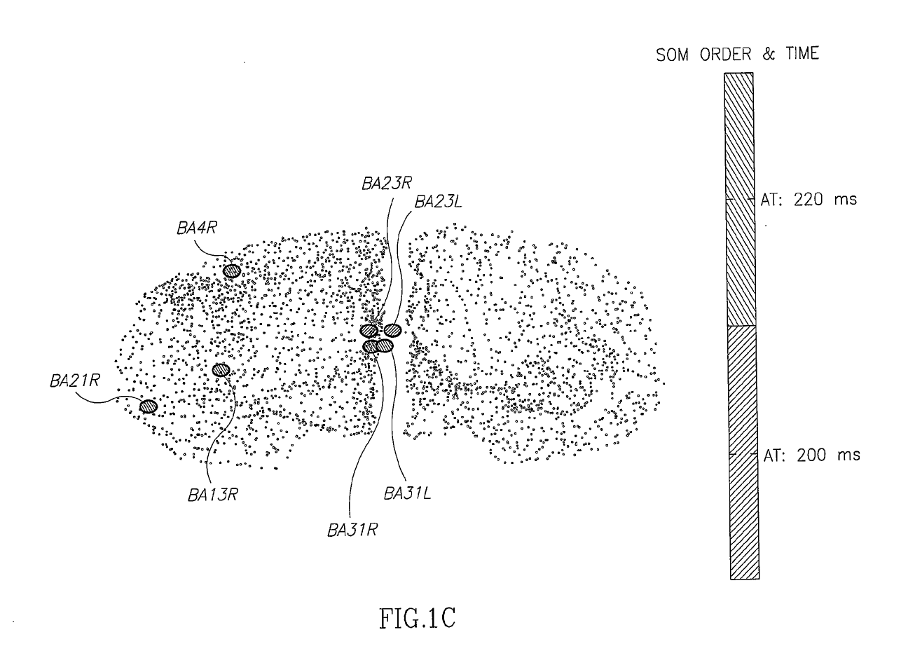

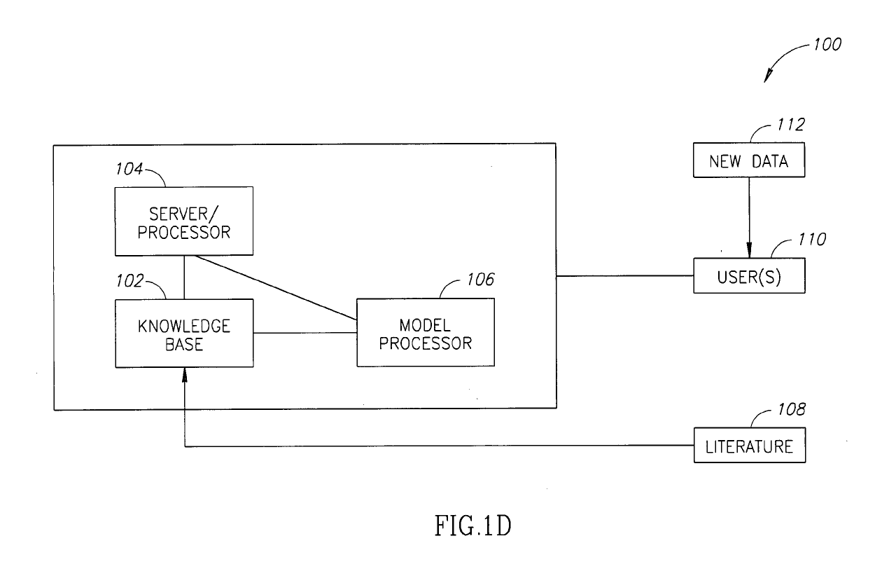

FIG. 1A-C depicts various views of neurophysiological data that may be utilized to abstract a neural model. FIG. 1A relates to an exemplary screenshot of software constructed according to some embodiments of the present invention. FIG. 1B depicts a graph of averaged EEG waveforms for signals obtained from three recording electrodes that are used to identify the localization maps of FIG. 1C showing the location of activity in a plurality of clusters in the brain. Neural modeling may optionally be used to determine the various sites identified by localization maps such as that depicted in FIG. 1C. Similarly, neural models may be optionally abstracted from the EEG electrode data as depicted in FIG. 1B.

Data analysis and processing of an EEG signal may lead to pattern and flow analysis that relate the activity of different regions of the brain to explain behavioral functions or pathologies or common sub-functions. Such information may optionally be compiled into a knowledgebase of data which preferably includes published neuropsychological literature. The analysis of published neuropsychological literature preferably includes a description of possible flow patterns among functional brain regions relating to specific behavioral functions, sub-functions or pathologies. Currently, such functional flow information is not generally available in the literature, which usually describes the participation of certain regions in a certain behavioral function or pathology, often without reference to their functional flow relations with other regions in the specific function or pathology or in alternative functions. The knowledge base, in turn, enables improved source localization and analysis of spatiotemporal patterns, by posing constraints regarding possible flow patterns among functional regions. Therefore the flow patterns may be used to abstract different models optionally using that described in the literature or from direct experimentation.

FIG. 1D depicts an exemplary, illustrative system 100 according to an optional embodiment of the present invention that may optionally incorporate data for example including but not limited to flow patterns, EEG raw data, localization maps or the like to abstract a neural model. System 100 preferably comprises a processor 104, a knowledgebase 102 and a model processor 106. Model processor 106 is preferably used to abstract models and process models. Optionally historical data available in the literature 108 is transcribed and incorporated into knowledgebase 102 of system 100. Similarly, user(s) 110 for example a researcher or health care provider may optionally interact with system 100 to abstract a neural model based on new data 112. New data 112 may optionally be used to abstract new models that may be used to expand and update knowledgebase 102. New data 112 may for example come in the form of but is not limited to raw EEG data, flow patterns, localization maps or the like.

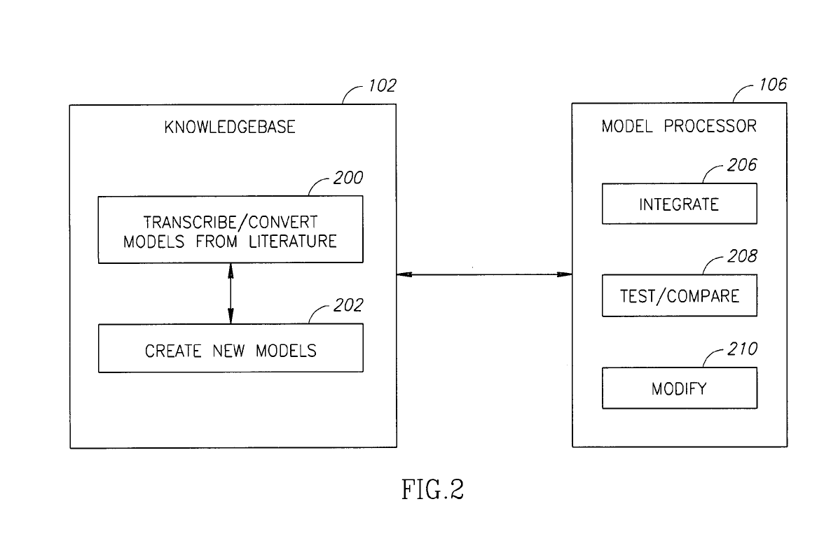

Model processor 106 and knowledgebase 102 of FIG. 1D are depicted in further details in FIG. 2, in an exemplary embodiment. Model processor 106 optionally and preferably interacts with the knowledgebase 102 of FIG. 1D to create and update the models already incorporated into the knowledgebase. Model processor 106 optionally and preferably comprises integrating module 206, testing and comparing module 208, and modifying module 210 that are used to process various models allowing a user to actively modify a neural model. Knowledgebase 102 interacts with model processor 106 to update and upkeep the neural models stored in knowledgebase 102. Preferably, knowledgebase 102 is compiled from literature based models 200 and newly created models 202 through its interaction with model processor 106.

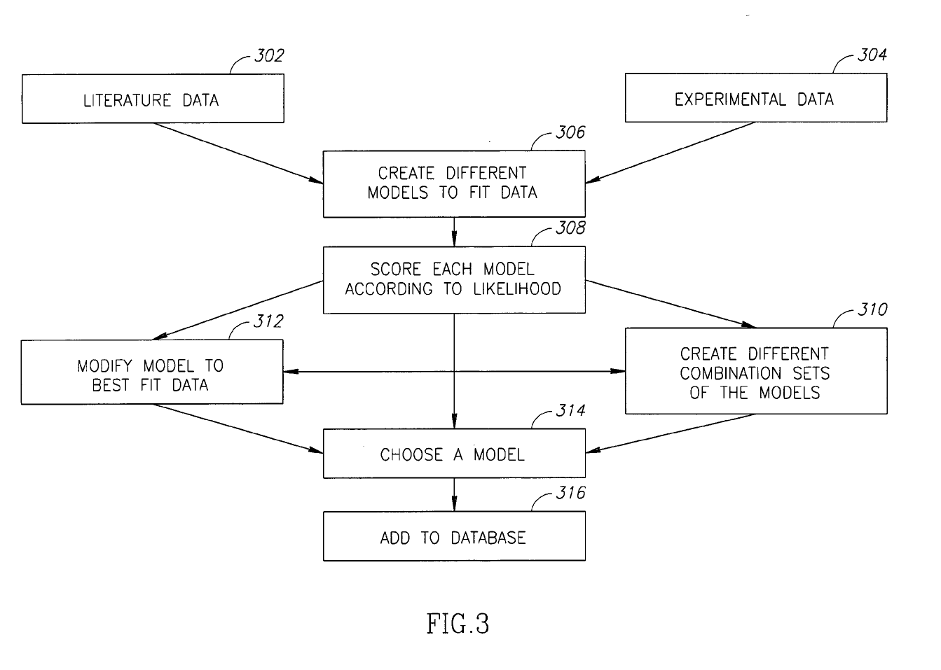

Reference is now made to FIG. 3, which is a flow chart illustrating an optional embodiment of the stages to create a new neural model based on a data from multiple sources, for example including but not limited to literature data 302 and experimental data 304 or the like. This data may optionally be compiled from subjects from the different research groups. A research group is defined as a group of subjects with similar behaviors. The behaviors may be actions or activities which are performed in a specific way due to a pathological condition, or the behaviors may be non-pathological actions which the subjects are requested to perform, for example. A research group may also include a control group for comparison with a group having or suspected of having a certain pathological condition or a control group for comparison with a group performing the action. Activity data of subjects are grouped according to research groups for example, a target group and a control group.

The data is then used to create different models in stage 306. Preferably, the model processor (not shown) of the present invention is able to abstract a number of models that are able to fit the data. Optionally and preferably, the different abstracted models are then scored in stage 308 optionally and preferably by a likelihood rating, reflecting the likelihood of the model fitting the data presented. Optionally and preferably a user may then alter and then test the abstracted models, ensuring that the best model has been chosen.

In stage 310, optionally the user may create different combination sets of the models for further testing. In stage 312, one or more models may optionally be altered to better fit the test data.

Interactive stages 310 and 312 may optionally be performed more than once to construct and refine the model that best suits the data. Once the interactive stages yield a satisfactory neural model, the user preferably chooses a specific model(s) in stage 314 which is then saved into the knowledgebase in step 316.

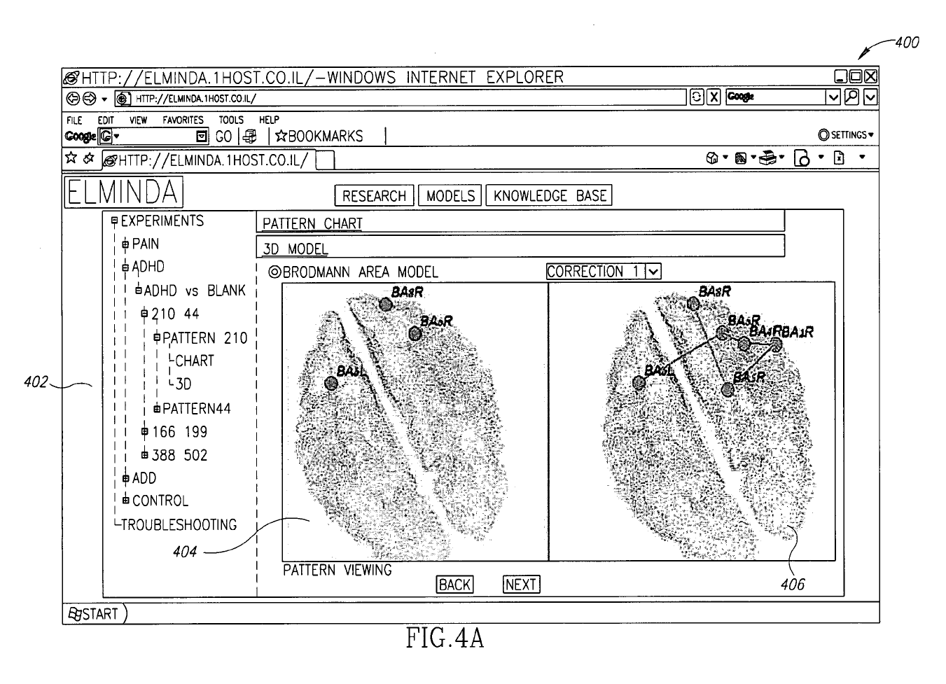

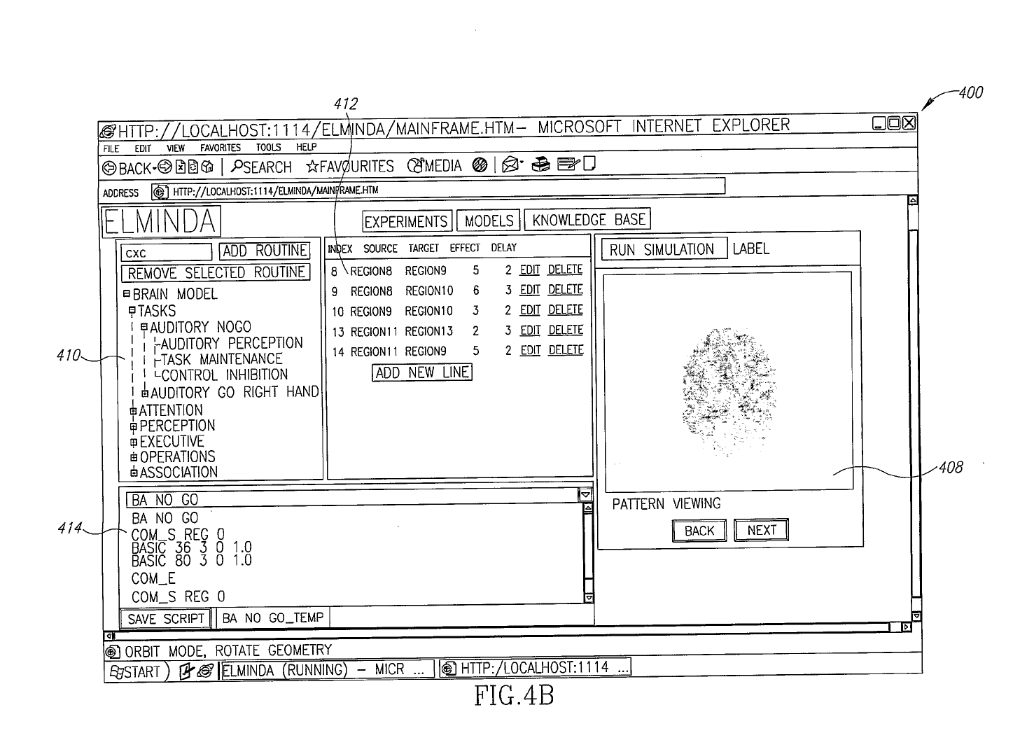

FIG. 4A depicts an exemplary screen shot of user interface 400 of the system and method of the present invention, in which a suggested or abstracted model 404, which is preferably based on actual collected data, is modified according to the method described in FIG. 3 to create model 406 that is believed to better suit the given data and flow. Each such corrected model 406 is preferably shown as a correction; optionally, a plurality of potential corrected models 406 may be displayed (not shown). User interface 400 further depicts the functional or spatial models 402 that may be optionally selected.

FIG. 4B shows another exemplary screen shot of user interface 400 of the system and method of the present invention, which relates to the operation of a simulator according to some embodiments of the present invention. The simulator may optionally be used to adjust the data for the model, for example by adding or removing data points that are incorporated in the model. Various methods which are known in the art may be optionally used for this process, including but not limited to minimum spanning trees, Steiner trees and the like. Next, optionally and preferably, the simulator may be used to “run” the data, by generating the real time patterns of data that would be expected if the model is correct. Such real time generation may also optionally be used to show if there are any aspects of the data that the new or corrected model does not fit or explain.

The simulator may optionally and preferably prune the data tree or other model of the data to remove points, but may also optionally add points from the data as being relevant. Such points may optionally relate to source localization and/or direct data (such as signals from an electrode for example); however, preferably the points relate to activity in particular regions of the brain. The process employed by the simulator enables a researcher or clinician to adjust the model without being an expert in model building.

Turning now to the area of interface 400 on the right, a graphical representation of the simulation 408 is displayed. Such a graphical representation is preferably accessible to the user once the model has been selected and the “run simulation” button is pressed or otherwise selected. Optionally and preferably, the data pattern is shown as well during the simulation, for example relating to any patterns found in the raw data, more preferably including EEG data (not shown).

To assist the user in selecting the correct model, the user preferably first selects a model type from a list 410. The list 410 is preferably structured according to a hierarchical tree, with leaves of the tree representing specific areas of brain activity, as for example auditory activity as shown. Higher up within the hierarchy, preferably collections of brain activities are represented, as for example with regard to particular diagnoses and/or cognitive tasks as shown. The selected model also preferably relates to a relationship between areas of the brain.

Next, a list of brain areas for which relevant activity is expected from the model is shown as activity list 412. The activity list preferably shows the network or brain area to which the activity belongs, as for example auditory activity (not shown). As previously described, the relationship between a first source area of activity and a second target area of activity is preferably also shown, more preferably according to the level of strength and delay (the latter refers to the length of time that elapses between location activities of source and target). Optionally one or more parameters may be added according to other data as well (such as physiological data for example; not shown). Also optionally the model may be refined according to one or more of data from the literature and multiple trials from a single patient and/or from multiple patients.

A script may optionally be constructed and/or adjusted and/or selected as shown in script window 414. The script may optionally be constructed in a different software program, as for example the software program E-Prime as a non-limiting example. E-Prime is a software applications suite for conducting psychological and neuroscientific experiments, developed by Psychology Software Tools (PST). This software enables the user to construct experimental scripts, for example regarding which type of stimulus should be offered, when and for how long. The simulator preferably uses the same language for script construction and in fact is preferably symmetrical with the actual test to be performed. This enables the investigator to use the same terms and structure for the test and for the simulator.

The simulator may optionally comprise a library of literature models, which may then optionally and preferably be adjusted by the researcher.

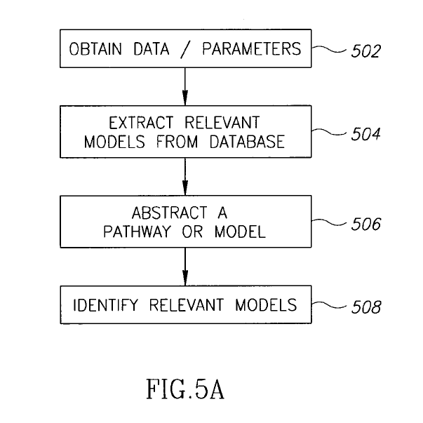

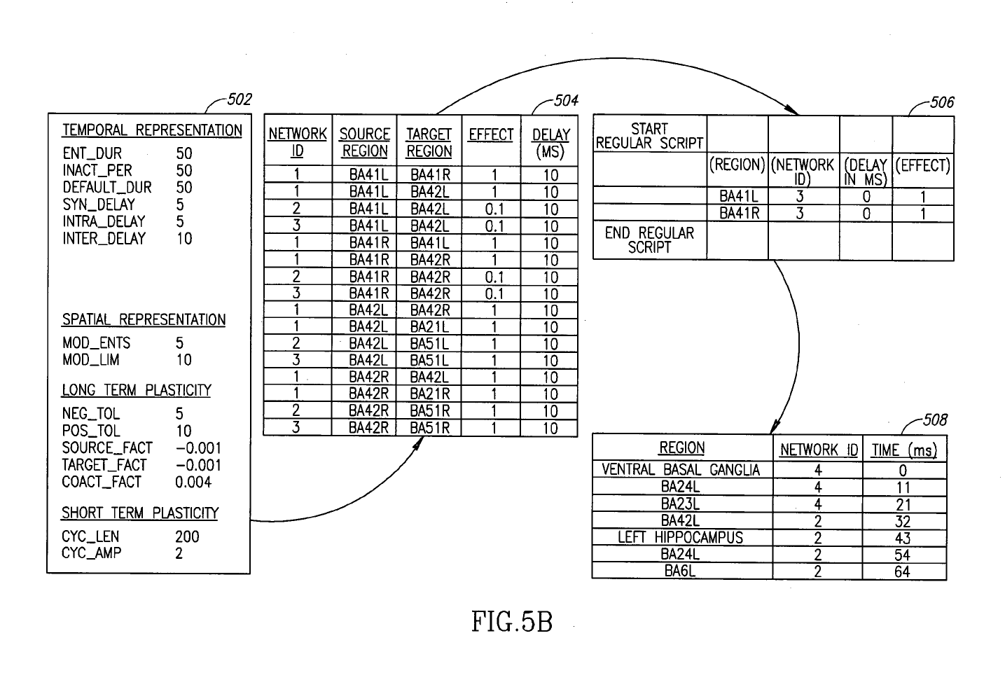

FIG. 5A is an optional depiction of how a user may interact with the system and method of the present invention. In stage 502 data, for example optionally in the form of raw EEG data, flow diagrams, localization maps or the like is obtained from a user. Preferably, such data includes source localization data and patterns obtained from the application entitled “FUNCTIONAL ANALYSIS OF NEUROPHYSIOLOGICAL DATA” co-filed by the present inventors and owned in common with the present application, the contents of which are hereby incorporated by reference as if fully set forth herein. Such data preferably includes neurophysiological global parameters of representation and plasticity.

In stage 504 preferably a plurality of relevant models are abstracted from the knowledgebase. FIG. 5B below shows an example from the neuropsychological knowledgebase, marked as element 504. The table contains the relations between pairs of regions (Source &Target regions) in specific functional network (Network ID). Each relation is characterized by effect of activation (Effect) and conduction delay (Delay).

The models abstracted at stage 504 are tested and a script is provided in stage 506 to identify relevant models in stage 508.

FIG. 5B is a practical example of the stages described in FIG. 5A. As shown in box 502, a plurality of different parameters is preferably provided in the model. For example, temporal representation is related to delay. The subsequent listed parameters are exemplary of temporal representation. ENT_DUR—entity duration; a spike of activity for the network of neurons, which may also be considered to be a pulse. This parameter relates to duration of the pulse. It is measured in milliseconds (for example 50). INACT_PER—inactivation period; it measures how long recovery takes after activation of the brain area. DEFAULT_DUR—provides an estimate of the duration. SYN_DELAY—synchronization delay. INTRA_DELAY—within an area. INTER_DELAY—delay period for interaction between areas.

Spatial representation relates to the number of entities or areas of the brain in the model. MOD_ENTS—number of entities (areas) in model. MOD_LIM—max limit of entities.

Long term plasticity may optionally have various parameters; it relates to long term changes in the brain. For example if two groups of neurons and/or brain areas are functioning together, then the connection between them is maintained. This process enables the brain to learn. NEG_TOL—negative tolerance—inhibition of working together. POS_TOL—positive tolerance—increased tendency to work together.

SOURCE_FACT—source and target for combination—relationship. This parameter relates to the strength of the connection between them (ie the extent to which each one operates individually as opposed to operating together).

Short term plasticity relates to the ability of the brain to adjust quickly but then to “forget” the learned activity or behavior. Cycling of activity relates to many short term bursts of activity, as for example seen in many short term bursts of sound. CYC-LEN—Cycle length (how long is the cycle); CYC-AMP—cycle strength to maintain plasticity.

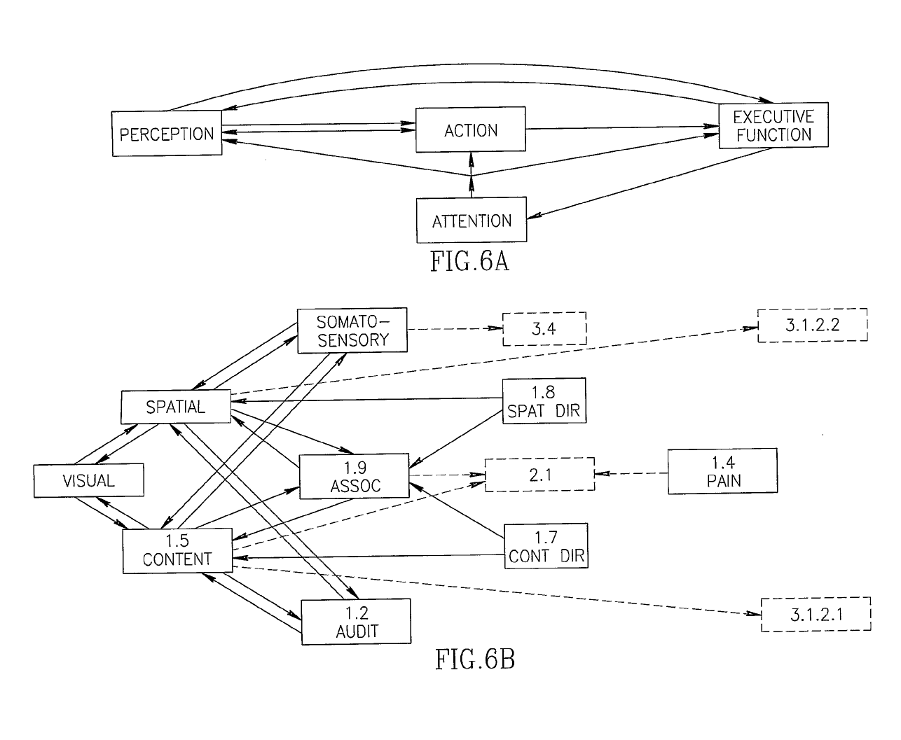

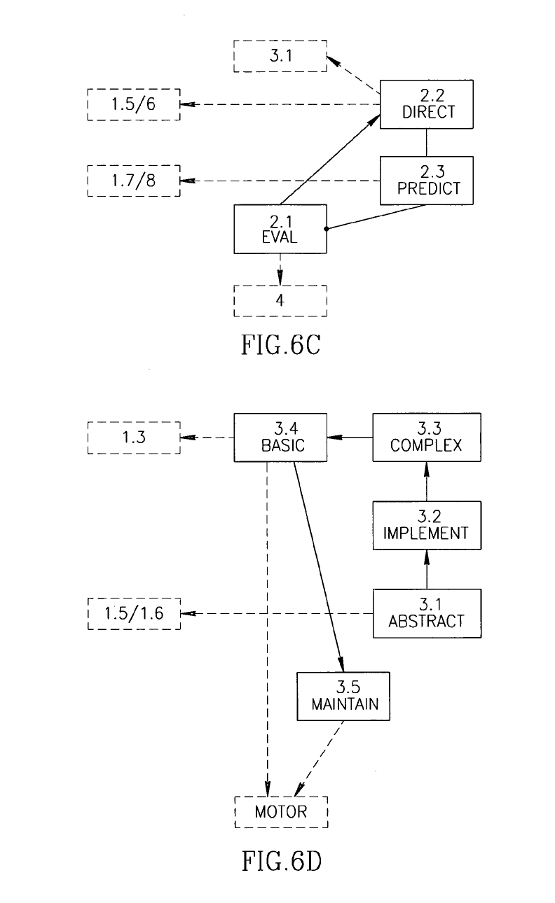

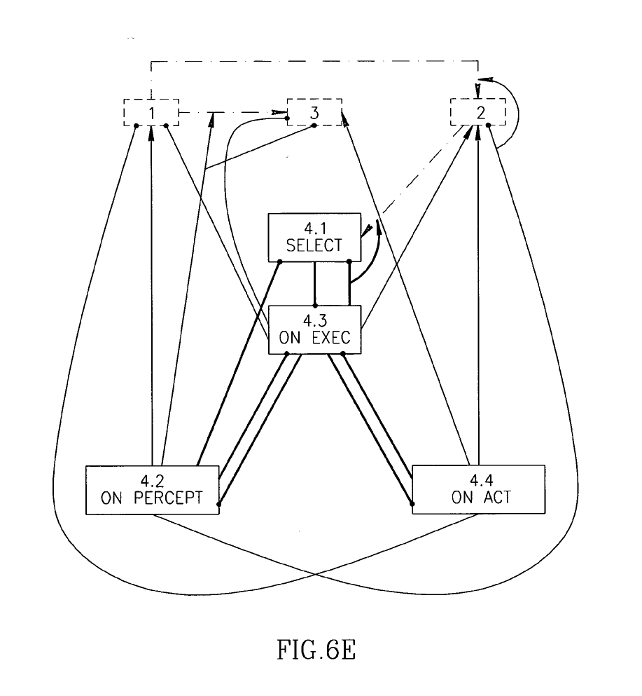

Several examples of flow patterns showing connectivity between functional regions is shown in FIGS. 6A-6E and associated Table 1 which relates functional regions to the numbering on the figures. These diagrams were formed based on published literature that may optionally be used to create a neural model according to an optional embodiment of the present invention. It should be readily apparent that these are merely examples, and do not necessarily represent actual patterns. Moreover, many alternatives may be suggested based on theory and experimental findings.

FIG. 6A is a diagrammatic representation of global interrelationships between an action, perception, executive function and attention. FIGS. 6B-6E are more specific diagrammatic representations of perception, executive function, action and attention, showing relationships and interrelationships between different areas of the brain which are functional during these activities. Similar models may be created for particular tasks, behaviors or activities, as described with respect to the present invention.

TABLE 1
Modules

| Functional module | Hemi | BA | Neuroanatomy |
|---|---|---|---|
| 1. Perception | | | |
| 1.1. Visual | | | |
| 1.1.1. Primary visual | X | 17 | |
| 1.1.2. Secondary visual | X | 18 | |
| 1.1.3. Tertiary visual | | | |
| 1.1.3.1. Objective oriented | Lt | 19 | |
| 1.1.3.2. Subjective oriented | Rt | -″- | |
| 1.2. Auditory | | | |
| 1.2.1. Primary auditory | Bi | 41 | |
| 1.2.2. Secondary auditory | Bi | 42 | |
| 1.2.3. Tertiary auditory | | | |
| 1.2.3.1. Objective oriented | Lt | 21, 22 | |
| 1.2.3.2. Subjective oriented | Rt | -″- | |
| 1.3. Somatosensory | | | |
| 1.3.1. Primary somatosensory | X | 1, 2, 3 | |
| 1.3.2. Secondary somatosensory | X | | Parietal |
| | | | operculum |
| 1.4. Pain | | | |
| 1.4.1. Primary pain | X | | Posterior Insula |
| 1.4.2. Secondary pain | | | |
| 1.4.2.1. Objective oriented | Lt | | Anterior Insula |
| 1.4.2.2. Subjective oriented | Rt | | -″- |
| 1.5. Heteromodal content | | | |
| (a) Objective oriented | Lt | | |
| (b) Subjective oriented | Rt | | |
| 1.5.1. Visual-Auditory | | 37, 20 | |
| 1.5.2. Visual-Somatic | | 39 | |
| 1.5.3. Global | | 38 | |
| 1.6. Heteromodal spatial | | | |
| 1.6.1. Body | X + Rt | | Superior |
| | | | parietal lobule |
| 1.6.2. Milieu | X + Rt | | Inferior parietal |
| | | | lobule |
| 1.7. Short term content direction | | | |
| 1.7.1. Objective oriented | Lt | | Ventral |
| | | | posterior |
| | | | cingulum |
| 1.7.2. Subjective oriented | Rt | | -″- |
| 1.8. Short term spatial direction | X | | Dorsal posterior |
| | | | cingulum |
| 1.9. Association | | | |
| 1.9.1. Objective oriented | Lt | | Hippocamus + pa |
| | | | rahippocampal |
| 1.9.2. Subjective oriented | Rt | | -″- |
| 2. Executive function | | | |
| 2.1. Significance evaluation | | | |
| 2.1.1. Objective oriented | Lt | | Amygdala |
| 2.1.2. Subjective oriented | Rt | | -″- |
| 2.2. Executive direction | | | |
| (a) Content direction | LT | | |
| (b) Spatial direction | RT | | |
| 2.2.1. Top level | | 9, 10 | |
| 2.2.2. Basic level | | 46, 47 | |
| 2.3. Outcome prediction | | | |
| 2.1.1. Objective oriented | Lt | | Ventromesial |
| | | | prefrontal |
| | | | cortex |
| 2.1.2. Subjective oriented | Rt | | -″- |
| 3. Action | | | |
| 3.1. Abstract action | | | |
| 3.1.1. Content action | Lt | 44, 45 | |
| 3.1.2. Spatial action | Rt | -″- | |
| 3.2. Implementation | X | | Medial |
| | | | cingulum |
| 3.3. Complex action | | | |
| 3.3.1. Body | X | 6 | |
| 3.3.2. Eyes | X | 8 | |
| 3.4. Basic action | X | 4 | |
| 3.5. Action maintenance | II | | Cerebellum |
| 4. Attention | | | |
| 4.1. Process selection | | | |
| 4.1.1. Executive selection | | | |
| 4.1.1.1. Content selection | Lt | | Ventral basal |
| | | | ganglia |
| 4.1.1.2. Spatial selection | Rt | | -″- |
| 4.1.2. Implementation selection | X | | Dorsal basal |
| | | | ganglia |
| 4.2. Perceptual attention | U | | Locus Ceruleus |
| 4.3. Executive attention | U | | Ventral |
| | | | tegmental area |
| 4.4. Action attention | U | | Raphe nuclei |

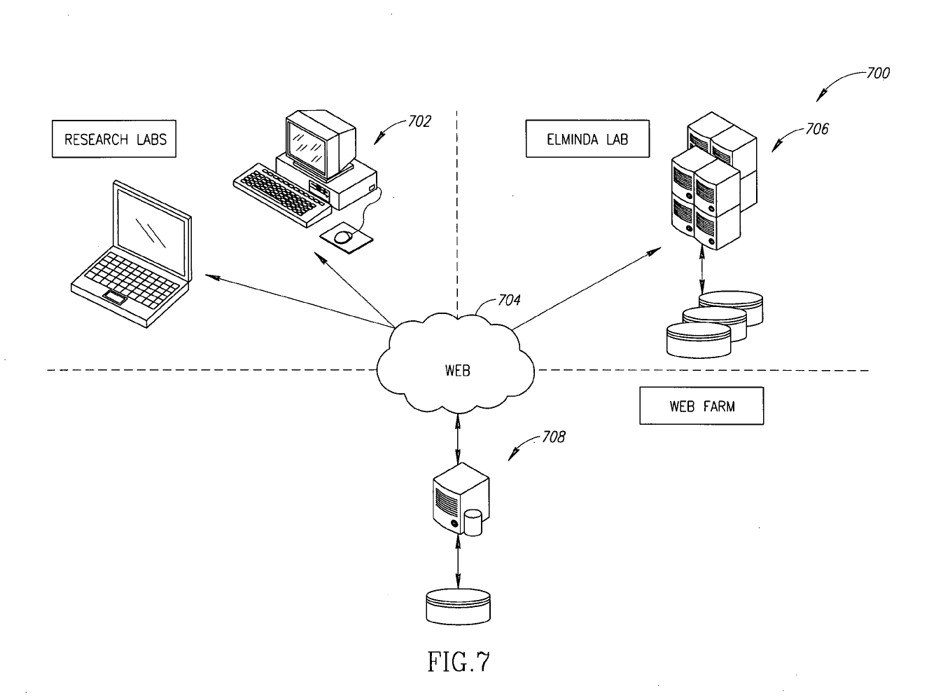

FIG. 7 relates to an exemplary embodiment of a system according to the present invention. As shown, a system 700 preferably features a user computer 702. User computer 702 preferably enables on-line communication for the user (not shown) through a computer network 704. By “online”, it is meant that communication is performed through an electronic communication medium, including but not limited to, telephone voice communication through the PSTN (public switched telephone network), cellular telephones or a combination thereof; exchanging information through Web pages according to HTTP (HyperText Transfer Protocol) or any other protocol for communication with and through mark-up language documents; exchanging messages through e-mail (electronic mail), messaging services such as ICQ® for example, and any other type of messaging service; any type of communication using a computational device as previously defined; as well as any other type of communication which incorporates an electronic medium for transmission.

User computer 702 preferably communicates with a model repository 706. Models may optionally be accessed and more preferably simulated through model repository 706. Optionally such data and interactions are performed through a web server 708 as shown.

A system such as the one described can potentially be used for many neurological and psychiatric conditions such as rehabilitation of brain injuries, treatment of neurocognitive dysfunctions and treatment of behavioral and emotional pathologies and problems. It should be noted that non-clinical applications are also ample, such as analysis of decision making, analysis of mood, analysis of personality and in general analysis of any behavioral function. Furthermore, the above system may also optionally be used for performing any of the above described methods, for example by having a computer perform the method to generate the model. Preferably, the result of the model is then displayed to a user, for example through the above described system.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While certain features of the present invention have been illustrated and described herein, many modifications, substitutions, changes, and equivalents may occur to those of ordinary skill in the art. It is, therefore, to be understood that the appended claims are intended to cover all such modifications and changes as fall within the true spirit of the present invention.

1-21. (canceled)

22. A method of constructing at least one neural model, comprising:
using a user interface for obtaining neurophysiological data;
identifying flow patterns in said data; and
analyzing said flow patterns to construct the at least one neural model.

23. The method according to claim 22, further comprising accessing a database of previously constructed neural models wherein said analysis is based on said previously constructed neural models.

24. The method according to claim 23, further comprising updating said database using the at least one neural model.

25. The method according to claim 22, wherein said at least one neural model is a plurality of neural models and the method further comprising scoring said models according to a predetermined likelihood rating.

26. The method according to claim 22, wherein said at least one neural model is a plurality of neural models, wherein the method further comprises arranging said plurality of neural models into a hierarchical structure according to areas of brain activity.

27. The method according to claim 22, further comprising using the at least one neural model for generating simulated data.

28. The method according to claim 27, further comprising comparing said simulated data to said neurophysiological data and correcting the at least one neural model based on said comparison.

29. The method according to claim 22, further comprising obtaining an experimental script and applying said experimental script to the at least one neural model for generating simulated data corresponding to said experimental script.

30. The method according to claim 22, wherein said neurophysiological data comprise data acquired from multiple subjects for a particular behavioral process.

31. The method according to claim 22, wherein said neurophysiological data comprise data pertaining to as spontaneous brain activity.

32. The method according to claim 22, wherein said neurophysiological data comprise data acquired before performing a task and data acquired during or after performing said task.

33. The method according to claim 22, wherein said neurophysiological data comprise source localization data.

34. The method according to claim 22, wherein said neurophysiological data comprises raw EEG signals.

35. The method according to claim 22, wherein said neurophysiological data comprises raw MEG signals

36. The method according to claim 22, wherein said neurophysiological data comprises brain imaging data.

37. The method according to claim 22, wherein the at least one neural model comprises information pertaining to brain network activity (BNA).

38. The method according to claim 37, wherein said BNA comprises relationships between source areas of activity and target areas of activity, said relationships being characterized by at least one of level of strength and delay.

39. The method according to claim 22, further comprising, subsequently to said construction of the at least one neural model, using said user interface for obtaining additional neurophysiological data and updating the at least one neural model responsively to said additional data.

40. The method according to claim 22, further comprising modeling functional plasticity and incorporating said functional plasticity in the at least one neural model.

41. The method according to claim 22, further comprising modeling a disease state and incorporating said disease state in the at least one neural model.

42. The method according to claim 22, further comprising modeling a normal brain state and incorporating said normal brain state in the at least one neural model.

43. A system for constructing at least one neural model, comprising:
an input unit for obtaining neurophysiological data from at least one subject; and
a data processor configured for:
using a user interface for obtaining neurophysiological data,
identifying flow patterns in said data, and
analyzing said flow patterns to construct the at least one neural model.
